(19) United States
(12) Patent Application Publication
(10) Pub. No.: US 2009/0007853 A1
(43) Pub. Date: Jan. 8, 2009

(54) STACKABLE TRAY SYSTEM AND METHOD TO LOAD, TRANSPORT, STUN AND SINGULATE POULTRY

(75) Inventors: John E. Johnson, Jefferson, SD (US); Adam Pfeifer, Dakota Dunes, SD (US); Amber Gosnell, Rogers, AR (US); Ted Burnett, Fayetteville, AR (US)

Correspondence Address: HUSCH BLACKWELL SANDERS LLP, 720 OLIVE STREET, SUITE 2400, ST. LOUIS, MO, 63101, US

(73) Assignee: TYSON FOODS, INC., Springdale, AR (US)

(21) Appl. No.: 11/773,265

(22) Filed: Jul. 3, 2007

(51) Int. Cl. A01K 31/07; A22B 3/00

(52) U.S. Cl. 119/453; 452/57; 452/66

(57) ABSTRACT

A system and method for handling poultry comprising a harvesting system, a loading system, a transport system, an unloading and storing system, a stunning system, and a singulate and hanging system. The system and method performs the steps of harvesting live poultry into stackable transport trays, stacking and loading the trays on a transport, unloading and temporarily storing the poultry for subsequent stunning and hanging. The stackable transport trays are well vented and easier for handling poultry.

### BACKGROUND OF INVENTION

1. Field of Invention

This invention relates generally to handling and transporting live poultry and, more particularly, to loading, transporting and unloading poultry.

2. Background Art

Transportation of live animals is a challenging task. The animals have to be gathered, contained and transferred to a transport means with minimal damage or harm to the animal, which is challenging because animals instinctively resist such movement. For example, transport of live poultry from growing houses to processing facilities is often required. One method of transport of live poultry is containing the birds in cages and stacking the cages on a truck with a flatbed trailer for transport. Loading and unloading trailers with live animals, particularly from a location where the animals are grown or raised to a processing facility, can in the case of chickens, increase the stress level of the animal. With heightened stress, animals are more likely to have increased body temperature, experience bruising, dislocated wing/leg joints and potential tissue damage along with an increased pH level, which may affect the quality of the muscle. Once the birds are captured in cages, the cages must be loaded on the trailer. Loading of the cages on the trailer consumes the full time of one operator to move cages from the house or growing area to the trailer and it requires skill to stack cages on the trailer so that they can be properly secured for transport. The cages often become damaged in this operation over time and need to be repaired and eventually replaced. Damage to the cages often involves the doors through which the birds are inserted. Poorly operating doors leads to increased time to load cages and potential bird damage.

Currently there are two methods in which to remove poultry from houses and load onto trucks. Both methods utilize cages which have a one door opening in which birds are placed. In the manual method, a catching crew of people (6-8) physically picks up 3-4 birds per hand to place the birds into the cages. The legs of the birds are laced between the fingers of the people catching. The birds are carried to the opening of the cages in an inverted state. This method of catching and transporting the birds to the cage is a risk to both the health of the birds and handlers. The birds are inserted into the open cages, adding to the stress of the birds and handlers. Once full, the door is closed. When a cage is full, a gas powered fork lift enters the house, places an empty cage on the floor and removes the full cage. The full cage is placed onto the flatbed semi-truck trailer. An empty cage is prepared and the cycle continues. It will take approximately 6 hours to remove poultry from a house with this manual method. There are obvious shortfalls with this method.

There are significant labor issues because it is very labor intensive and requires some level of skill and training. There are health issues for both the birds and the handlers. The labor intensive handling of the birds promotes infections of the handler and risks harm to the birds. This results in numerous health and safety concerns. The cages are prone for damage which can cause bird damage and extensive time and labor is utilized to fill the cages with birds and load and secure them for transport.

An enhanced mechanical method can use equipment to guide the poultry forward and to the sides of the houses while mechanical means capture the poultry and transfer them onto a take-away conveyor. One of the two methods utilizes two opposite rotating drums with rubber “fingers” spaced to allow birds to be captured between the fingers. The drums are mounted on a telescoping arm which moves in an arc from the base unit. Another method uses the same drums mounted horizontally to the ground. The drum mechanism is normally mounted on a modified garden tractor. The second method utilizes belts that are mounted on a head, extending from a conveyor. Belts are two feet long, two feet wide and angled at approximately 15 degrees.

Loading of poultry is a cumbersome and time consuming task. In the catching process, the poultry are placed into cages. Some cage designs consist of “drawers” and can vary from 10 to 15 drawers averaging a 20-25 bird capacity per drawer. Birds can be placed into the cages either manually or by semi-automatic means. A forklift then can load a flatbed truck with 18-22 cages that are stacked in pairs. Once the cages are in place, each stack has to be secured by chains to the frame of the trailer.

Semi-automated methods of harvesting the birds in the houses have encountered mechanical and functional problems. In one sense this semi-automated method eliminates the need for operators to physically pick up the birds. However, operators are still needed to operate the equipment and to move the birds forward and away from the sides of the house. Therefore, some handling is still necessary. One major short fall is the type of power needed for these mechanical harvesters. The designs of the various types are petroleum and hydraulically powered and may not meet the load placed on them. These lighter designs lead to breakdowns and decrease the efficiencies of the harvesting.

Another problem is the staging of the equipment. The machinery is large and cumbersome and requires a separate trailer to move from farm to farm, and needs loading and unloading. The size of the different equipment requires the houses to be built larger and have wider openings. These wider openings are problematic in two ways. The birds are disturbed while the machinery is being moved into place, thus the sudden exposure to daylight and activity excites the birds, leading to increased stress. Secondly, as the machinery goes deeper in the house, the petroleum powered equipment generates exhaust fumes that can build up and can be detrimental to both the operators and birds.

As mentioned, several issues are associated with loading of poultry. The operation as described above inherently causes stress on the birds. This stress leads to increased risk of physical damage to the birds due to their excited state and increased movement resulting in, for example, bruises and dislocated wing and/or leg joints. The loading of the cages, again, is time consuming, difficulties in cage stacking, and damage to cages over time.

As discussed above, flatbed trucks can be used to transport loaded cages from the farm to respective plants. The cages can be secured to the flatbed truck by means of chains which have to be manually placed. There are several issues and problems with the current method of transporting chickens and they are - Debris on the road (feathers, fecal matter, dirt, etc.); Stress on the bird (temperature extremes); Potential damage to birds; Unloading of the birds at the plant; Cleaning of the cages and truck; and Repair and replacement of cages.

Currently, the cages are simply loaded on the truck and the cage doors facing outwards with the sides exposed. The animals are exposed to the outside environment and there is no control over the temperature or conditions. Therefore, during the summer there is increased animal temperature and conversely in the winter, reduced temperatures. Other weather conditions adversely affecting the animals are wind, rain and snow. Travel to the facility and weather conditions can adversely affect the process of getting birds into the processing facility and also increases the amount of stress on the birds.

Currently, the trailers arrive at the processing facility and are staged in an area where, depending on the weather, the birds are cooled by large fans and possibly misters. With the processing lines continually operating, a “pocket” of birds are needed to ensure production is not hampered. Therefore, a number of trailers are staged at the facility and coordination of the trailers is critical to assure the efficiency of the process.

Once the trailer is ready for unloading, a forklift can approach the side and lift a cage off the trailer. Damage can occur at this point both to the trailer and the cage. The cage can then be transported to the dock of the plant and is set into a piece of equipment called a “cage dumper”. The dumper can have a hydraulic lift that will aggressively tilt the cage at approximately 20-45 degrees and the birds will slide out of the cage. A method of engaging and disengaging the hydraulic pressure is often utilized to “shake” any remaining birds from the cage. Damage is most likely to occur in this process due to the falling of the birds, flapping of wings, dumping angle and the increased stress placed on the birds. Sometimes human intervention is needed to remove some birds which may have been caught in the cage. When all birds are removed, the forklift operator can remove the cage from the cage dumper, place it on an empty trailer, and repeat the process until the loaded trailer is empty. Not only does this process expose the birds to a lengthy time on the trailer waiting to be unloaded but it consumes labor and capital (forklift and trailer staging).

Once the birds are removed from their cages at the live hang area, the birds are hung upside down by their feet in shackles. In order to calm the birds, this area is dark with black lights that assist the team members' sight. Team members collect a bird by its feet and place the feet into respective shackles moving in front of the team member. The shackled birds are conveyed through an electric stunner in which a current is passed through the bird and renders it unconscious. This is a widely accepted and effective means in which to stun a bird.

Current methods in the US poultry industry use an electric stun to render the birds unconscious prior to the killing machine. As the bird is in an inverted position, the head is moved through a trough of water with an electrode in the bottom which makes a complete circuit to the shackles holding the feet. There are different models of this stunner but all function in the same manner.

As noted above, problems occur with harvesting, placing birds into cages, loading the cages on a transport, and transporting to the processing facilities. A new system and method for harvesting, loading, transporting, unloading and stunning is needed that addresses the above problems. Particularly, a new cage design is needed to assist in solving some of the above problems.

### BRIEF SUMMARY OF INVENTION

The invention is a system and method for handling poultry comprising a harvesting system, a loading system, a transport system, an unloading and storing system, a stunning system, and a singulate and hanging system. The system and method performs the steps of harvesting live poultry into stackable transport trays, stacking and loading the trays on a transport, unloading and temporarily storing the poultry for subsequent stunning and hanging. The invention more particularly relates to a new container design for holding the animals for transport.

The concept of harvesting poultry from houses will be made more efficient and result in less worker and animal stress by resolving many of the problems related to the current method of manually catching birds and placing in cages or using semi-automated systems to place birds into cages. With the present invention, stackable trays can be utilized instead of cages. The trays can be made from molded plastic or aluminum metal with rounded corners and open grid flooring and sides. The bottoms can have an open grid pattern bottom to allow the birds to grasp with their paws to stabilize and reduce wing flapping. The grid pattern also allows debris and litter to fall out to reduce cleaning and increased airflow to ventilate the birds. The top and bottom perimeter edges of the cages can be complimentary in shape for ease of stacking and stability reducing lateral movement of the stacked trays with respect to each other. The sides of the trays can also have vented openings. Once an upper tray is stacked on top of a lower tray, birds placed in the lower tray are contained. The upper most tray in a stack of tray can be capped by an additional empty tray or other cover.

An empty stack of trays can be transferred into a poultry house manually or by a powered mover or conveyor. The tray stacks can be manually or mechanically un-stacked for loading poultry. After poultry are loaded into the trays and the trays are stacked, a powered mover can transport the trays to the outside to be loaded onto the trailer. The trays should be stacked by placing the next loaded tray directly overhead of the previously loaded tray to avoid sliding the trays onto one another and pinching chicken heads, thus eliminating the problem seen with drawer cages. The birds can be either hand or mechanically caught to place in the trays. An alternative method for loading the birds is to leave all the trays and equipment on the outside of the house to reduce animal stress and use a large powered conveyor platform to bring the birds outside to load into the trays. The large powered conveyor platform can be loaded by hand or machine, then driven outside where the belt indexes to load an empty tray. The stacking equipment can be designed to present an empty tray for loading and then move it into a stacking position. After the trays are loaded and stacked, a powered mover can take the trays to the trailer for loading. A plurality of trays can be utilized to remove all the birds from the house.

The construction of the trailer can be a flatbed trailer with vertical framework to make up the structural integrity as well as to hold the stacks of individual trays. There can be a plurality of vertical and horizontal rails to insure the structure and flexibility of the size and number of trays capable of handling. The loaded trays can be raised into the end of the trailer and tracks built into the floor will slide the loaded trays to the front until fully loaded.

This transport system eliminates the cages completely and provides an environment in which the level of stress for the animals is significantly reduced. The sides and flooring of the trays provide increased air movement to cool the animals when the trailer is moving as well in the static positions such as at stop lights and in city environments. Duct work and fans can be incorporated into the transport to improve the ambient condition for the animals and optimize the environment during transportation.

Currently, the cages are simply loaded on the truck and the cage doors facing outwards with the sides exposed. The animals are exposed to the outside environment and there is no control over the temperature or conditions. Therefore, during the summer there is increased animal temperature and conversely in the winter, reduced temperatures. Other weather conditions adversely affecting the animals are wind, rain and snow.

With the design of the present invention, there can be a frame work constructed on the transport trailer holding a lightweight material that can be pulled alongside the trailer to cover the sides. This shroud can create an envelope in which the environment can be better controlled and provide a more suitable environment for the animals. Secondly, the amount of debris that is associated with transporting live animals with exposed cages (fecal matter, feathers, dirt, chicken litter, etc.) will be eliminated. The aesthetic features of the transport can be improved as the exterior of the truck can be capable of displaying logos, company signage, etc.

Once the trailer arrives at the plant, the trays can be unloaded and automatically moved into a warehouse. This process can be performed as trucks arrive in order to build an entire storage of birds for a production shift. The trucks can be automatically unloaded in a very short period of time, thus eliminating the need for a forklift. The system can work in a first in first out method. This new system will keep the animals in a more controlled environment and reduce stress level and therefore reduce bruises and dislocated wing joints. By filling the warehouse with birds, the process can be improved through the efficiency of bringing the birds to the stunning area and not consuming time loading and unloading cages.

The automated unloading can be done automatically to push the trays off the side of the truck in the stacked formation onto either a conveyor or pull chain system. The conveyor can take the trays to the staging area where they can be un-stacked manually or by using destacker equipment. From this arrangement, the trays can easily be used with the current conventional electrical stunner setup or a controlled atmosphere stunning (CAS) system.

With the proposed method, the trays provide a perfect transport to move the birds through a gas stunning system. This system can eliminate the double handling of the birds and possibly make the process more efficient as the hanging of a stunned (static) bird can be easier than hanging an active bird.

The trays can be automatically removed from the storage racks and travel through the stages of gas stunning. The first stage can include conveying the trays containing live poultry through a first chamber, which can be an induction phase of the process where the live poultry is subjected to an atmosphere comprising CO₂ and O₂, where in one embodiment the atmosphere can constitute about approximately 17% to 37% by volume CO₂ and about approximately 15% to 35% by volume O₂ for about approximately 1 minute±15 seconds dwell times. The trays containing poultry can be conveyed to a second stage, which can be a second chamber, which can be referred to as a stun phase, where the poultry is subjected to an atmosphere of an increased volume of CO₂ with respect to the previous stage, for example the first stage, where in one embodiment an atmosphere of at least 35% by volume CO₂ for about approximately a 1 minute±15 seconds dwell time. The trays containing poultry can be conveyed to a third stage, which can be referred to as a final stun phase, where the poultry can be subject to an atmosphere having an increased volume of CO₂ with respect to the previous stage, for example stage 2, where in one embodiment an atmosphere of at least 55% CO₂ for about approximately a 1 minute±15 seconds dwell time. Once the birds have been rendered unconscious, the tray can exit the last chamber and tilt, allowing the birds to slide off into the hanging area. In this area, we will either have a sorting device or a manual method in which to singulate and hang the birds.

Other stunning methods such as electric, CAS, or a combination may be used with the tray system. An additional proposed method for incorporating CAS into the stunning method is to use it as an induction to the electric stun. By using a single induction phase of CAS to render the birds unconscious, the stunned birds can then go to the hanging area to be placed in shackles before the electric stunner.

There are a number of advantages to the design of the present invention for harvesting poultry. Safety is increased for the handler and the birds and health risks are reduced. The efficiencies of handling and transporting birds is improved and the process is less labor intensive and causes less stress on animals.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is a flow diagram illustrating the overall process flow of the system;

FIG. 2 is a perspective C-Channel Tray design;

FIG. 2A is an end plan view;

FIG. 2B is a side plan view;

FIG. 2C is a bottom plan view;

FIG. 2D is a perspective view of stacked trays;

FIG. 2E is an end plan view of stacked trays;

FIG. 3 is an illustration of manual loading into trays;

FIG. 3A is an illustration of a transport with a shroud;

FIG. 4 is an illustration of an automated loading;

FIGS. 4A and 4B are an illustration of an automated loading with a central conveyor;

FIG. 5 is an illustration of a truck with the trays loaded thereon;

FIG. 6 is an illustration of an empty trailer of a truck with the trays not loaded thereon; and

FIG. 7 is an illustration of a storage and stunning area.

### DETAILED DESCRIPTION OF INVENTION

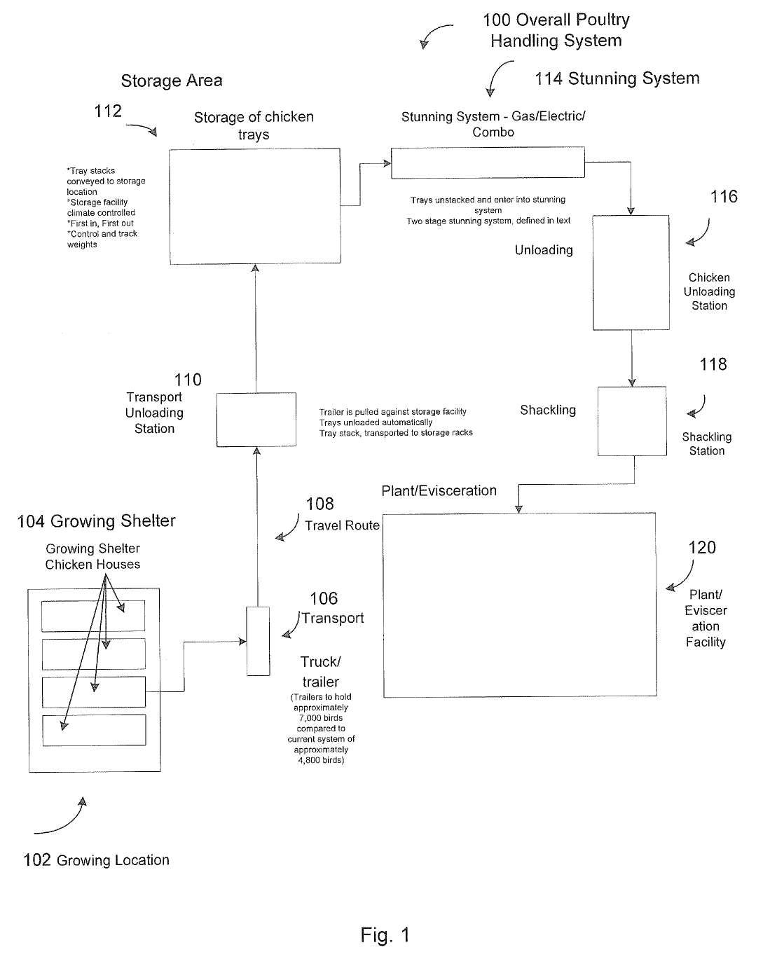

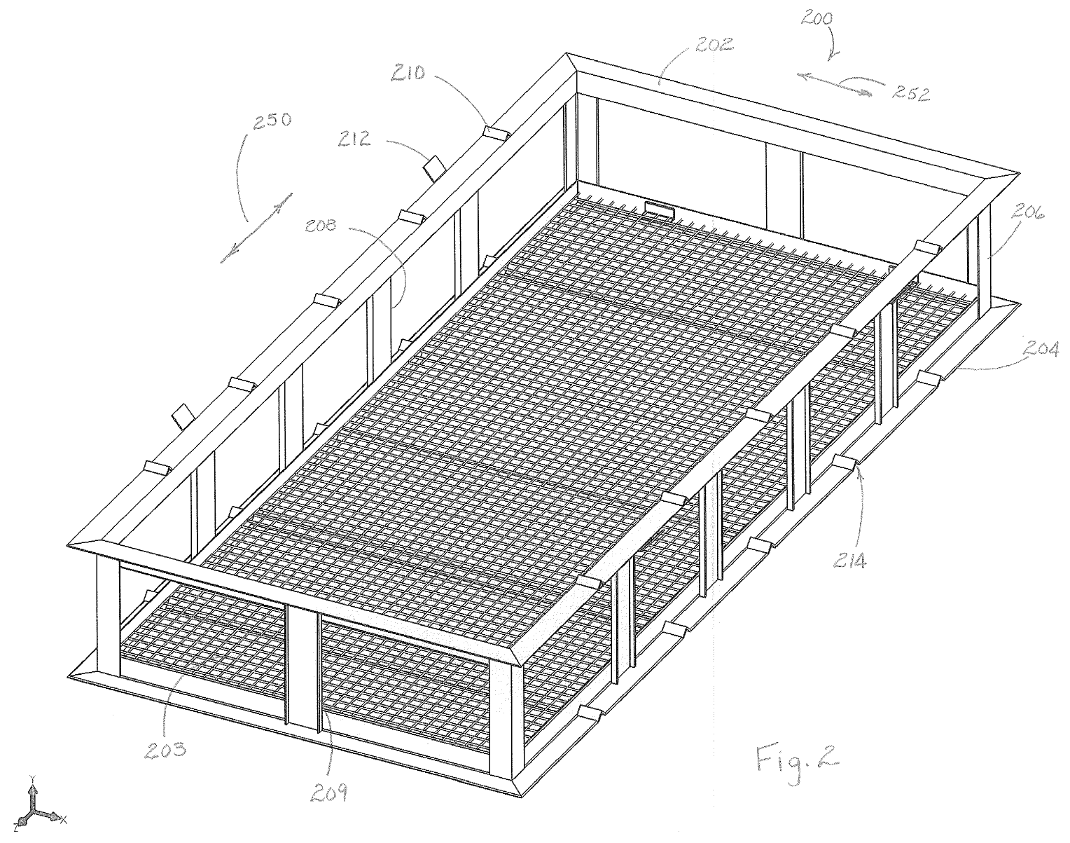

According to the embodiment(s) of the present invention, various views are illustrated in FIG. 1-7 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One embodiment of the present invention comprising a harvesting system, a loading system including a stackable tray design, a transport system, an unloading and storing system, a stunning system, and a singulate and hanging system teaches a novel system and method for loading, transporting, stunning, singulating and hanging poultry.

The details of the invention and various embodiments can be better understood by referring to the figures of the drawing. Referring to FIG. 1, a functional flow diagram is provided showing the overall flow of the poultry handling system 100. The poultry handling system can begin with the growing location 102 where the poultry are grown for future processing. At the growing location 102 there can be a series of growing shelters 104 for housing the poultry going through the growth process. When the poultry have completed the growth process they can be transported to a location for processing as a final food product. A transport 106 can arrive at the growing location to receive the poultry that have completed the growth process. In this illustration the transport system is a truck and trailer combination. The trailer can be a standard flatbed trailer on which containers containing the fully grown poultry can be loaded. When utilizing the present invention standard trailers can hold approximately 7,000 birds as compared to previous systems (typically cages) that could only hold approximately 4,800 birds. The transport 106 can be loaded with the fully grown birds and transported along a travel route 108 to an unloading station 110.

The unloading station 110 can include an automated unloading system for automatically unloading a tray stack for storage in an adjacent storage area 112. Tray stacks can be conveyed to a storage location having a climate controlled storage facility for housing the poultry in the stacked trays prior to the stunning and rendering process. The storage area 112 can be operated on a first in first out system such that a given tray stack does not dwell in the storage area for an extended period of time. The storage area can also have a system for controlling and tracking the weight of the tray stacks which could ultimately provide weight information regarding the fully grown poultry.

Within the storage facility there can be an automated tray unstacking system for unstacking the stacked trays for conveyance through the stunning system. The stunning system 114 can be a stunning system including a gaseous environment for stunning the poultry or it can include an electric shock stunning system or a combination of the two. If a gaseous environment stunning system is utilized, the gaseous environment can be a multi-stage stunning system where the first stage(s) can be a combined induction phase and the second stage(s) can be the combined stunning phase. This system can generally be referred to as a controlled atmosphere stunning system or CAS. Once the trays containing the poultry have transitioned through the stunning system 1 14, the poultry can be unloaded from the trays at an unloading station 116. The unloading station can comprise an automated unloading system which is operable to tilt the trays sufficiently to remove the stunned poultry from the trays. Once removed from the trays, the stunned poultry can be conveyed to a shackling station 118 where the poultry can be hung from a shackle conveyor for being conveyed to a plant evisceration facility 120.

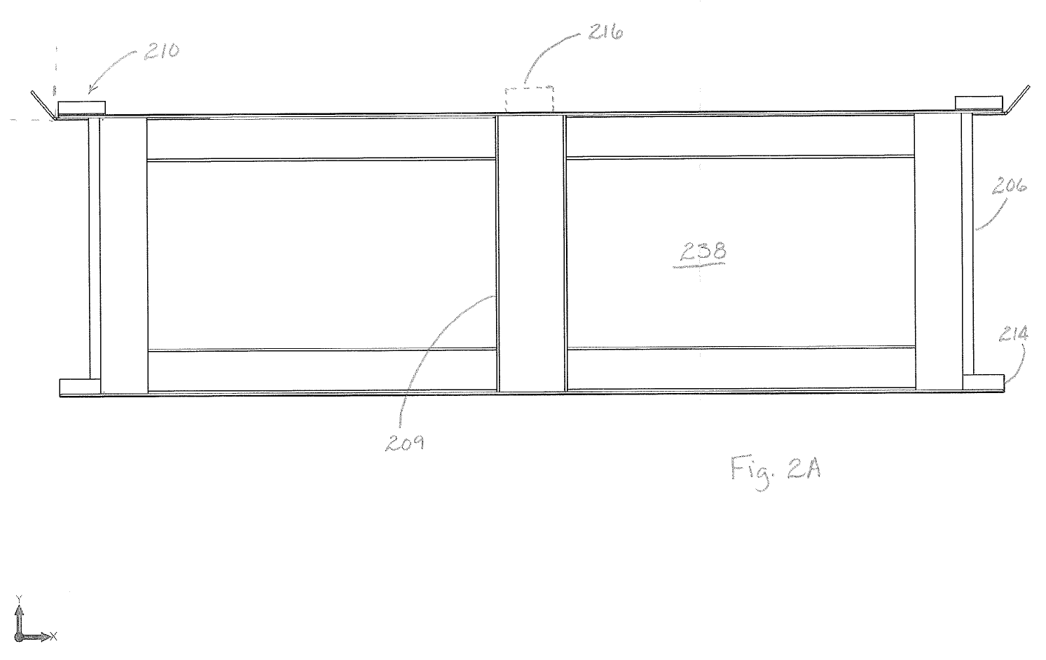

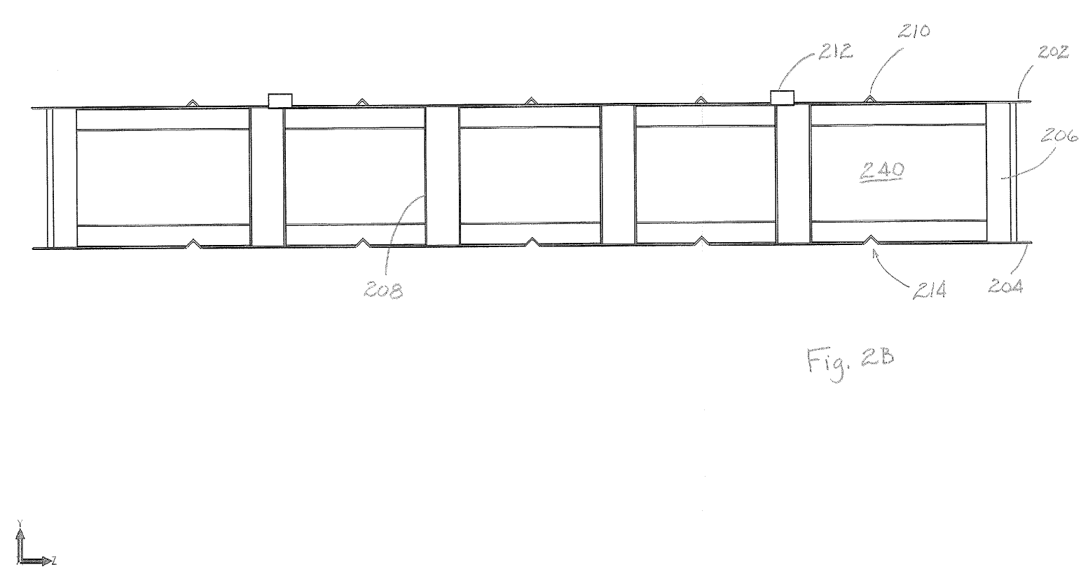

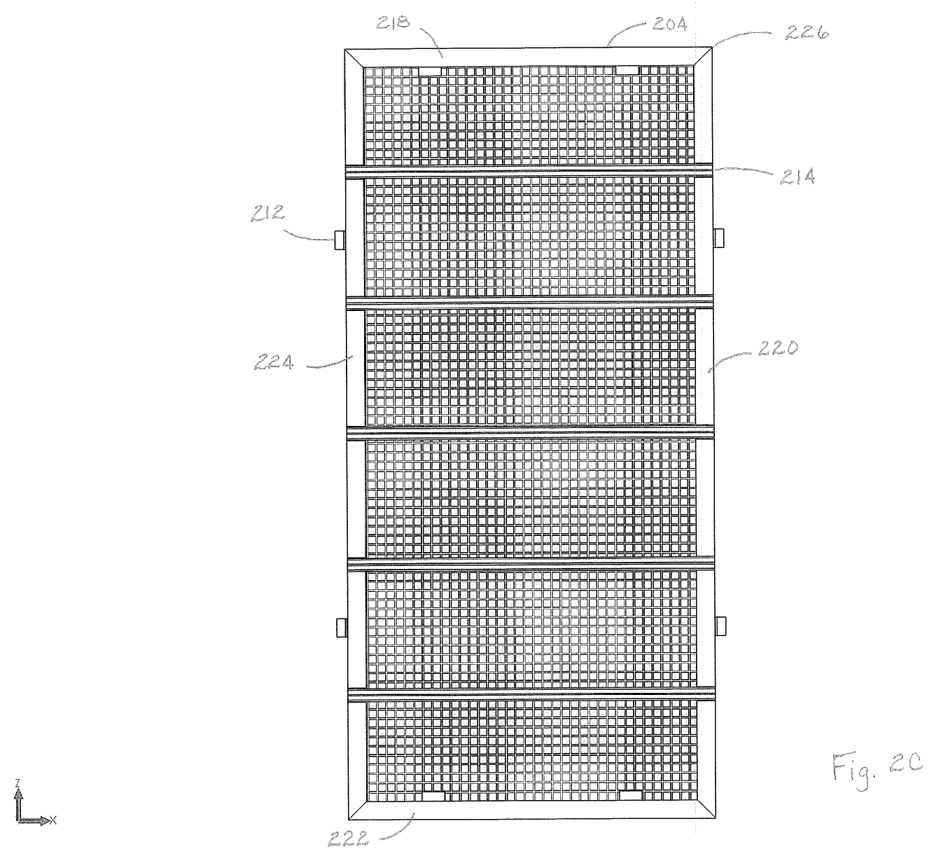

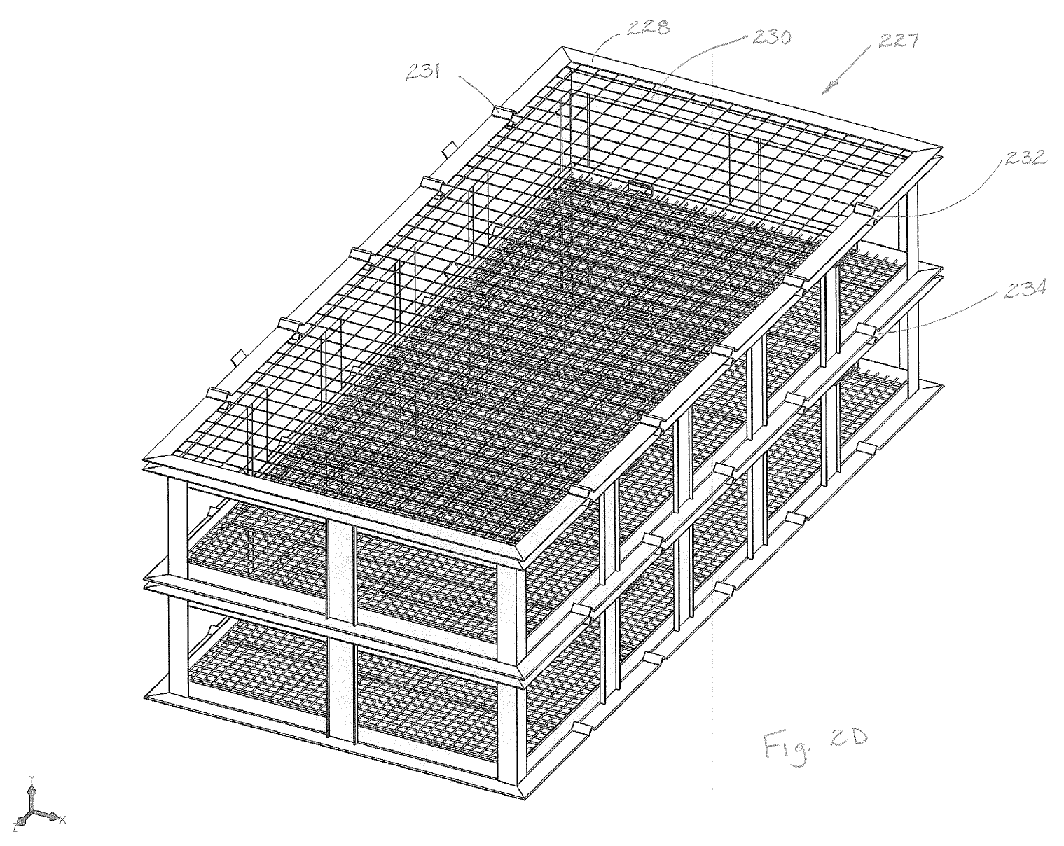

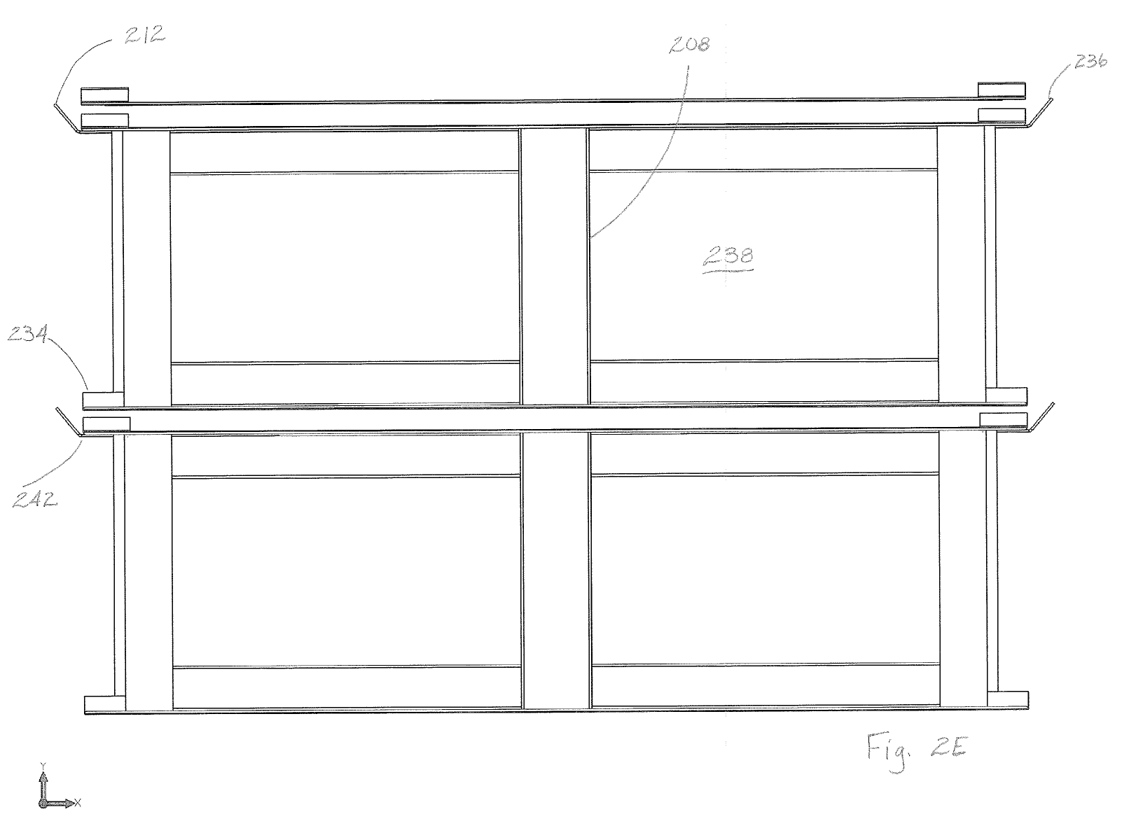

Referring to FIGS. 2 and 2A-2E, a perspective view of the stackable tray 200 is shown. The tray is shown having an interwoven wire mesh tray bottom 203 where the mesh openings are sufficiently large for debris to pass therethrough and also providing a means for the bird to grasp hold in order to stabilize itself. The frame of the tray 200 comprises various portions including perimeter top and bottom rim flanges and upright side rib members or which has side fence member having openings through which ventilation can occur. The upward facing surface portion of the upper perimeter top rim flange 202 can be designed to be complimentary with respect to the downward facing portion of the bottom perimeter rim flange 204. This complimentary configuration can be designed such that the trays interlock when they are stacked thereby resisting longitudinal and latitudinal movement of the trays with respect to each other.

The stackable tray 200 can be constructed as shown in FIG. 2 having a top rim flange 202 and a bottom rim flange 204, which defines the longitudinal and latitudinal dimensions of the tray. The top and bottom rim flanges can have L-shaped cross sections as shown. The inner perimeter of the top rim flange 202 can define an upper opening or upward facing opening through which birds can be easily inserted. The bottom rim flange defines the perimeter of the lower or downward facing opening closed off by the mesh screen floor 203. The mesh floor 203 is designed with vented openings where the openings are sufficiently large to allow debris to pass there through. The mesh floor and sides are critical for the maximum passage of gas through the system in the stunning stages. The mesh floor design also provides for a surface that can be grasped by the talons of a bird. Upright mesh side walls, not shown, can be attached around the perimeter of the tray and attached to the support rib members. Corner upright support rib members 206 and longitudinal upright support rib members 208, which define the opposing longitudinal sides of the tray, and latitudinal upright support rib members 209, which defines the opposing latitudinal side of the tray, extend substantially perpendicular with respect to and between and connecting the top rim flange and the bottom rim flange. The inner perimeters of the top rim flange and the bottom rim flange, which define the upper and lower openings respectively, can have substantially the same geometry. The plurality of upright members define the longitudinal 250 and latitudinal 252 side walls of the tray and their spacing there between define the vented side openings 238 and 240.

The top rim flange 202 can include a longitudinal stabilization tab 212 which can extend latitudinal from a longitudinal extending exterior side edge of the top rim flange. The tab can extend latitudinally away from the side edge as well as upward between vertical and horizontal with respect to the side edge such that latitudinal movement of a tray stacked thereon is significantly reduced. The top rim flange 202 can have on an upper surface and a latitudinal extending raised flange rib 210. The flange rib 210 and the complementing recessed channel 214 on the underside of the tray when engaged, one with respect to the other in a stackable fashion, the raised flange rib 210 can resist longitudinal 250 shifting of trays, one with respect to the other. The raised ribs can be placed along a longitudinal side of the top rim flange 202 and extending latitudinally. Optionally, the raised ribs 210 can be placed along both opposing longitudinal sides as shown in FIG. 2. Also, in order to add additional stability to the stacked trays, the raised ribs can also be placed along the lateral sides of the top flange. Also, the stabilization tabs 212 can be placed along the latitudinal sides of the top rim flange. The spacing between the longitudinal, the latitudinal, and the corner upright support ribs define the vented openings of the tray. The spacing between the support members and the height of the support members can be optimized depending on the type of bird being contained within the stackable trays. The sides can be covered by an upright mesh wall (not shown) attached to the side ribs.

FIG. 2C shows a plan view of the underside of the tray. The bottom rim flange 204 has opposing latitudinal extending side members 218 and 222 and longitudinal extending opposing side members 224 and 220. The members 218, 220, 222 and 224 can be connected at a seam similar to that of seam 226 as shown. This plan view of the underside reveals the recessed channel 214 that extends between the longitudinal side members 224 and 220 and underneath the mesh screen. The inner geometry of the recessed channel 214 can have dimensions to conform to the raised rib 210 and positioned longitudinally such that they coincide with the placement of the raised ribs 210, such that when one tray is stacked on top of the other, the interface between the recessed channel 214 and the raised rib 210 will be aligned and resist longitudinal shifting of the trays, one with respect to the other. The longitudinal stabilization tabs 212 are also seen from this plan view. This plan view reveals the outward extension of the stabilization tab 212.

FIG. 2A shows an end view of the tray which shows the vented opening 238 defined by the lateral upright support member 209 and the upright corner support member 206. This end view reveals the option of utilizing a stabilization tab 216 on a lateral side of the top rim flange. The upward protrusion of the raised rib 210 above the top surface of the top rim flange 202 is also shown. The complementary recessed channel 214 is also shown. FIG. 2B shows a side plan view of a tray, which reveals the longitudinal side vent opening 240. This opening 240 is defined by the corner member 206 and longitudinal side members 208. This side view also shows the top rim flange 202 and the bottom rim flange 204. The recessed channel 214 can also be clearly seen from this view. The upward extension of the raised rib 210 can also be seen.

FIG. 2D shows a perspective view of stacked trays where the uppermost tray has a top cover 227 installed. The top cover 227 can have a mesh screen 230 for covering the opening of the uppermost tray. The perimeter of the mesh screen can be defined by the top cover flange 228. The top cover flange can have recessed grooves for interfacing with the raised rib on the top rib flange of the uppermost tray. This stackable configuration shown in FIG. 2D shows the raised rib interface 234 with the recessed channel, as well as the raised rib interface 232 with the recessed groove of the top cover. FIG. 2E shows an end view of the stacked trays. The raised rib interface 234 and the tab interface 242 shown in FIG. 2E are designed to resist longitudinal and lateral movements or shifting between trays. The top tray in FIGS. 2D and 2E are shown exploded slightly above engagement with the tray below for illustrative purposes showing the complimenting engagement.

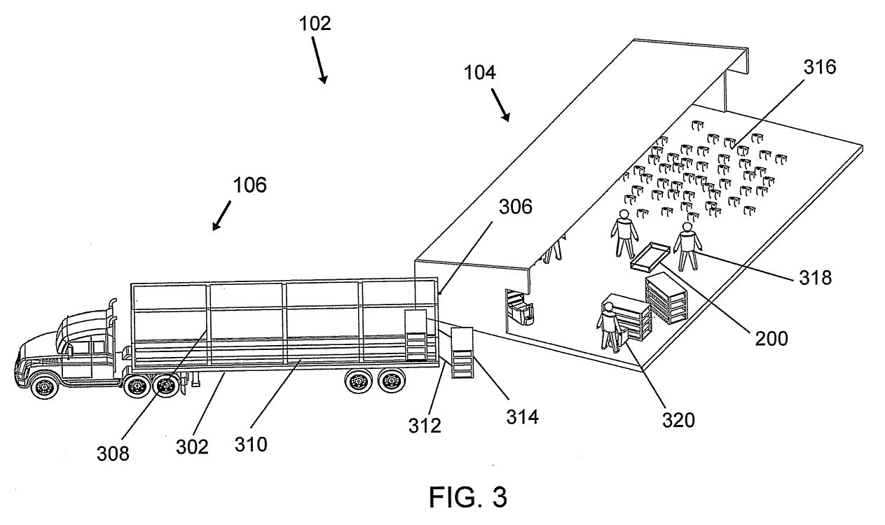

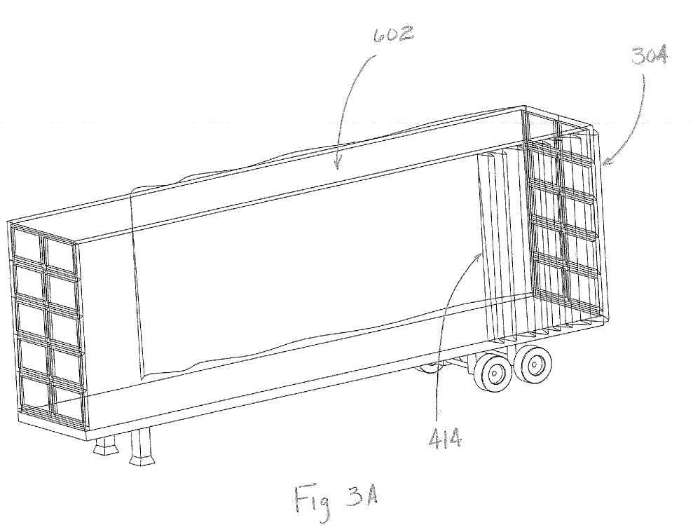

Referring to FIG. 3, an illustration is provided for the growing location 102. The growing location is shown comprising a growing shelter 104 for housing a plurality of birds 316. The transport 106 is shown positioned adjacent the growing shelter 104 for receiving the tray stacks 314. FIG. 3 illustrates a manual operation for loading the poultry and stacking them in the trays for loading on the transport. FIG. 3 illustrates a handler 318 who utilizes a tray 200 for loading multiple birds into the tray. Handler 318 then can stack the trays thereby capturing the birds therein. The stacked trays can be lifted and carried to the transport by a pallet jack 320 or other lifting mechanism for carrying the trays out of the growing shelter to the transport.

The tray stacks 314 can be transitioned to the transport 106 and loaded on the flatbed 302 by way of a transport ramp or loading dock or other means for loading the tray stacks. Tray tracks 310 can be provided on the flatbed for facilitating loading and sliding of the tray track along the flatbed. The tray tracks can be dimensioned to be receive by the recessed channel of the lower most tray in a stack. The transport 106 can have a shroud covering 304 for better controlling the environmental exposure of the poultry. The shroud covering 304 can be supported by transport side rails 308. One or both of the side panels of the shroud covering can be a retractable curtain 414 for exposing the flatbed from either side. The shroud covering can also have a rear transport cover opening 306 through which tray stacks can be loaded.

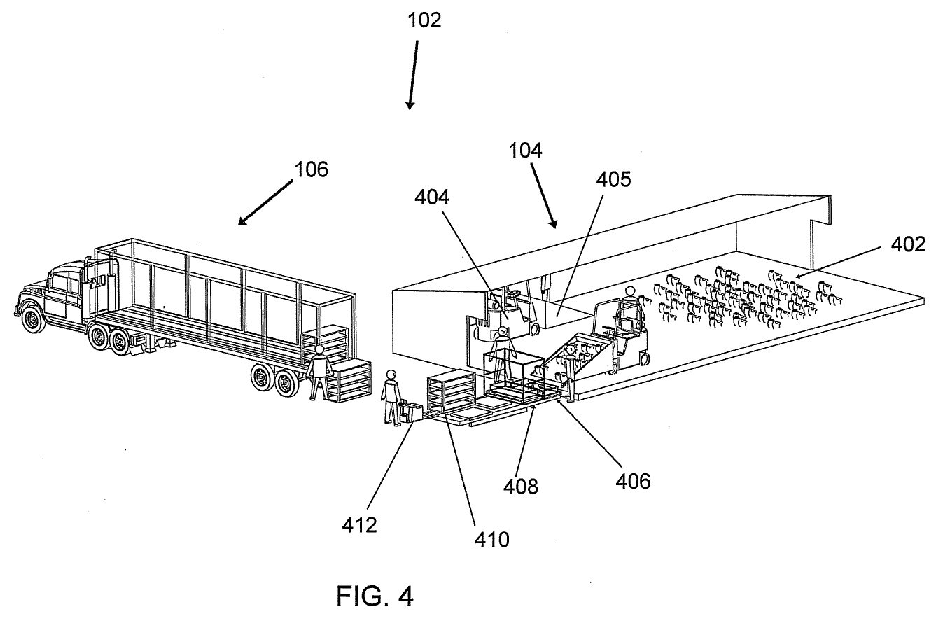

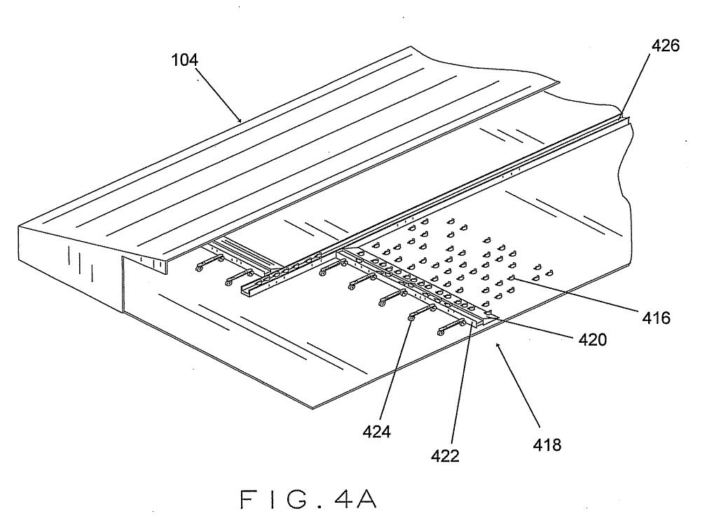

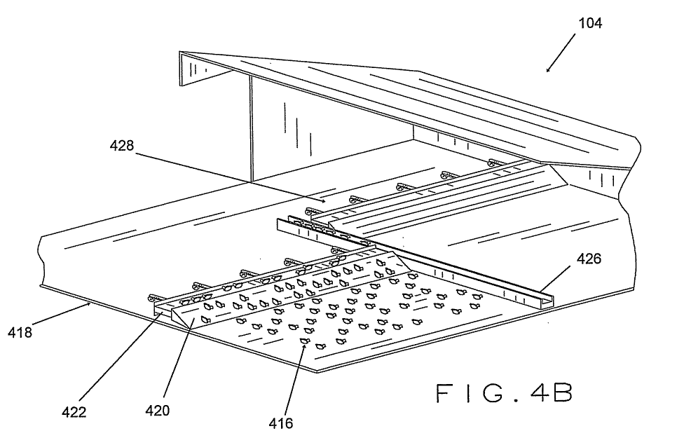

Referring to FIG. 4, an alternative illustration of the growing location 102 is shown. The growing location 102 can again include a growing shelter 104 for housing a plurality of birds 402. The handlers as shown in FIG. 3 can utilize a modified forklift 404 having a forward scoop implement 405 for harvesting the birds and transitioning the birds to a stacking conveyor ramp 406 for conveying the birds and loading them in individual trays. The stacking conveyor ramp 406 can be designed to convey the birds from the modified forklift 404 to a stacker system 408 which automatically stacks and loads the birds into the trays. Once a set of stacked trays 410 has been completed the stacked trays can be conveyed from the stacker system to a location where they can be captured by a forklift 412 for loading onto the transport 106.

This illustration shows the tray stacks being loaded from the rear onto the transport through an opening created by a retractable side curtain of the shroud covering 414. If a side loading method is utilized, the tray track that is shown in FIG. 3 can be reconfigured such that there are multiple tracks extending side-to-side on a flatbed for sideward loading of the stacked trays. FIG. 3 is illustrative of a predominately manual loading process whereas FIG. 4 is illustrative of a semi-automated loading process. However, FIGS. 4A and 4B are further illustrative of a fully automated harvesting system having a center conveyor 426 for conveying the birds to an automated stacker station as illustration as item 408 in FIG. 4. A growing shelter 104 can have a center conveyor 426 that substantially extends end-to-end for conveying the birds to a stacking station. A growing shelter can also include an automated harvesting system 418 which comprises a harvesting ramp 420 for urging the birds 416 onto a lateral conveyor 422 for lateral conveyance onto the center conveyor 426. The harvester system 418 can have drive wells 424 for allowing the harvester system to transition along the length of the center conveyor thereby transitioning the birds utilizing its lateral conveyor onto the center conveyor or conveyance to the stacker station. FIG. 4B illustrates two harvesters 418 and 428 for harvesting on both sides of the growing shelter 104.

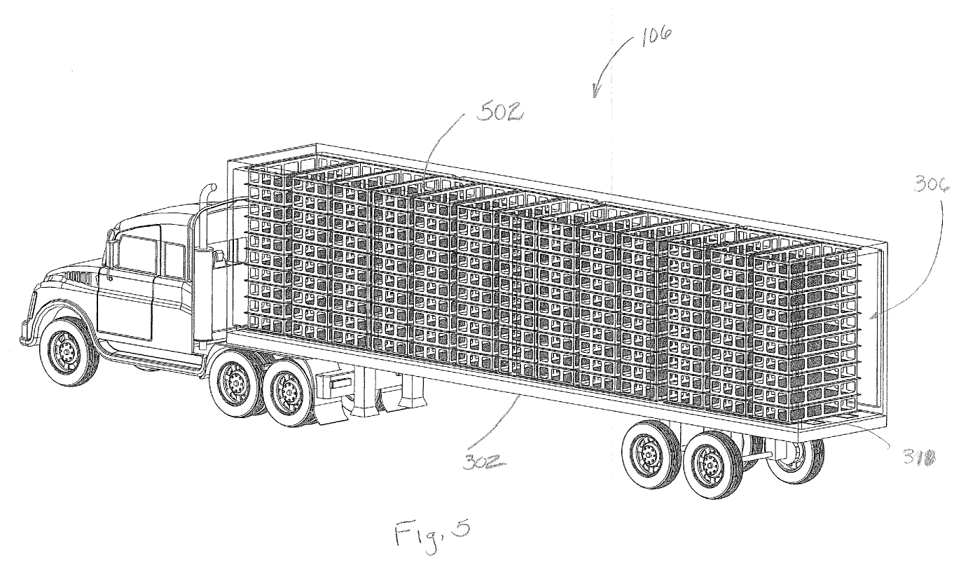

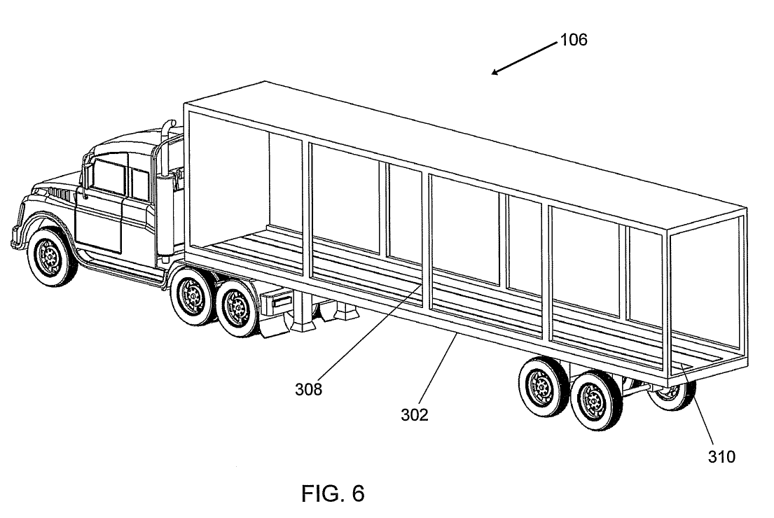

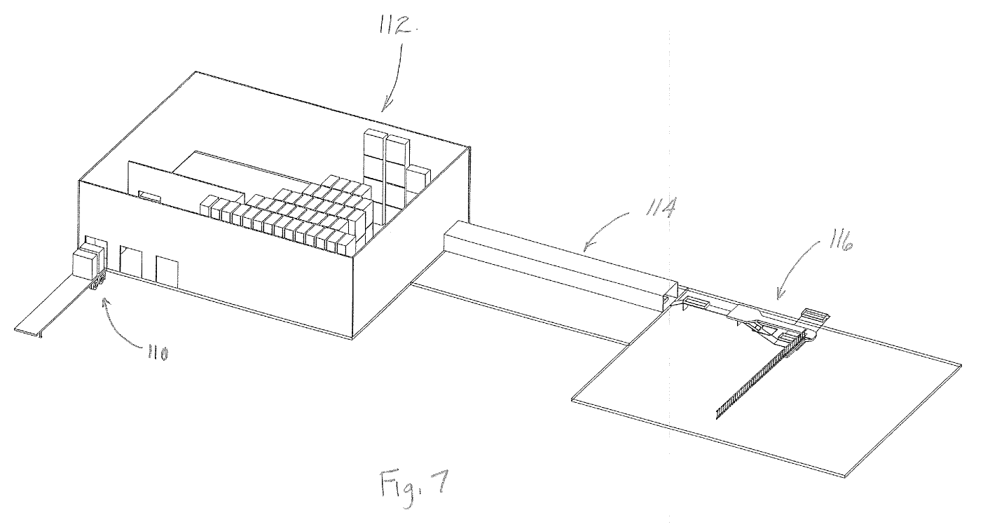

FIGS. 5 and 6 are further illustrative of a transport where FIG. 5 shows its transport in its loaded configuration and FIG. 6 shows the transport in its empty configuration. The stacked trays 502 can be loaded through the transport cover opening 306 by sliding them along tray tracks 310 which extend along the length of the flatbed. The trailer 302 can be a standard trailer; however, the trailer can have side railings 308 for supporting shroud covering 304. Again as illustrated in FIG. 4, the shroud covering 304 can have a retractable side curtain of the shroud covering for exposing one or both sides of the flatbed. The top surface of the flatbed can have raised ribs that conform to the recessed channels on the underside of the tray to restrict lateral sliding or movement of the bottom most tray. FIG. 7 is illustrative of a delivery location or processing facility for the poultry transport, which includes a transport unloading station 110, a storage area 112, a stunning system 114 and an unloading station 116.

The various poultry handling examples shown above illustrate a novel system and method for handling poultry. A user of the present invention may choose any of the above chicken handling embodiments, or an equivalent thereof, depending upon the desired application. In this regard, it is recognized that various forms of the subject chicken handling could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

Other aspects, objects and advantages of the present invention can be obtained from a study of the drawings, the disclosure and the appended claims.

What is claimed is:

1. A poultry container system comprising:
a. a tray having a perimetrical top rim flange defining an upward facing opening having a first geometry and a perimetrical bottom rim flange defining a downward facing opening where said downward facing opening is closed by a mesh screen and has a second geometry substantially identical to said first geometry of the top rim flange;
b. upright support rib longitudinal side members and upright support rib latitudinal side members perpendicularly extended between said bottom and top rim flanges such that said bottom and top rim flanges are in substantially parallel planes;
c. a first latitudinally extending raised rib protruding vertically from said top rim flange and said raised rib is spaced a first predetermined longitudinal distance from a latitudinal extending side of said top rim flange;
d. a first tab extending latitudinally and upward between vertical and horizontal from a side edge of said top rim flange; and
e. a first recessed channel extending latitudinally under said mesh screen and said channel spaced a first matching longitudinal distance from a latitudinal side edge of said bottom rim flange where said predetermined distance and said first matching distance are substantially the same.

2. The container system of claim 1, where the upward facing opening and the downward facing opening are rectangular and the top rim flange has opposing top latitudinal extending sides and opposing top longitudinal extending sides and the bottom rim flange has opposing bottom latitudinal extending sides and opposing bottom longitudinal extending sides.

3. The container system as recited in claim 2, further comprising:
a second latitudinally extending raised rib protruding vertically from said top rim flange and said raised rib is spaced a second predetermined longitudinal distance from the latitudinal extending side of said top rim flange; and
a second recessed channel extending latitudinally under said mesh screen and said channel spaced a second matching longitudinal distance from the latitudinal side edge of said bottom rim flange where said second predetermined distance and said second matching distance are substantially the same.

4. The container system as recited in claim 3, further comprising:
a second tab extending latitudinally and upward between vertical and horizontal from the side edge of said top rim flange and longitudinally spaced apart from said first tab.

5. The container system as recited in claim 4, where the first and second recessed channel extends between opposing bottom longitudinal extending sides.

6. A stackable poultry container system comprising:
a. a plurality of trays stacked vertically from tops of said trays underneath to bottoms of said tray above and engaging the top of each of said trays underneath with the bottom of said trays immediately above, where each of said trays further comprises;
a perimetrical top rim flange defining an upward facing opening having a first geometry and a perimetrical bottom rim flange defining a downward facing opening where said downward facing opening is closed by a mesh screen and has a second geometry substantially identical to said first geometry;
upright support rib longitudinal side members and upright support rib latitudinal side members perpendicularly extended between said bottom and top rim flanges such that said bottom and top rim flanges are in substantially parallel planes;
a first latitudinally extending raised rib protruding vertically from said top rim flange and said raised rib is spaced a first predetermined longitudinal distance from a latitudinal side of said top rim flange; and
a first recessed channel extending latitudinally under said mesh screen and said channel spaced a first matching longitudinal distance from a side edge of said bottom rim flange where said first predetermined distance and said first matching distance are substantially the same,
and said plurality of trays stacked where said recessed channel engages said raised rib immediately below.

7. The container system of claim 6, where the upward facing opening and the downward facing opening are rectangular and the top rim flange has opposing top latitudinal extending sides and opposing top longitudinal extending sides and the bottom rim flange has opposing bottom latitudinal extending sides and opposing bottom longitudinal extending sides.

8. The container system as recited in claim 7, further comprising:
a second latitudinally extending raised rib protruding vertically from said top rim flange and said raised rib is spaced a second predetermined longitudinal distance from the latitudinal extending side of said top rim flange; and
a second recessed channel extending latitudinally under said mesh screen and said channel spaced a second matching longitudinal distance from the latitudinal side edge of said bottom rim flange where said second predetermined distance and said second matching distance are substantially the same.

9. The container system as recited in claim 8, further comprising:
a tab extending latitudinally and upward between vertical and horizontal from the side edge of said top rim flange and longitudinally spaced apart from said first tab.

10. The container system as recited in claim 9, where the first and second recessed channel extends between opposing bottom longitudinal extending sides.

11. A method for containing poultry in a system of stacked trays for transport comprising the steps of:
a. gathering together live poultry in a plurality of trays comprising, a plurality of trays stacked vertically from tops of said trays underneath to bottoms of said tray above and engaging the top of each of said trays underneath with the bottom of said trays immediately above, where each of said trays further comprises,
a perimetrical top rim flange defining an upward facing opening having a first geometry and a perimetrical bottom rim flange defining a downward facing opening where said downward facing opening is closed by a mesh screen and has a second geometry substantially identical to said first geometry,
upright support rib longitudinal side members and upright support rib latitudinal side members perpendicularly extended between said bottom and top rim flanges such that said bottom and top rim flanges are in substantially parallel planes,
a latitudinally extending raised rib protruding vertically from said top rim flange and said raised rib is spaced a predetermined longitudinal distance from a latitudinal side of said top rim flange, and
a recessed channel extending latitudinally under said mesh screen and said channel spaced a matching longitudinal distance from a side edge of said bottom rim flange where said predetermined distance and said matching distance are substantially the same; and
a. stacking into a tray stack said plurality of trays vertically from tops of said trays underneath to bottoms of said tray above and engaging the top of each of said trays underneath with the bottom of said trays immediately above, where said recessed channel engages said raised rib immediately below.

12. The method as recited in claim 11, further comprising the step of:
transferring the tray stack to a flatbed of a transport and aligning the recessed channel of a lowermost tray over a flatbed raised rib.

13. The method as recited in claim 12, further comprising the step of:
surrounding the tray stack with a shroud support by a frame structure attached to the flatbed;
transporting the tray stack to another location; and unloading the tray stack.

14. The method as recited in claim 13, further comprising the step of:
unstacking the tray stack; and
conveying the plurality of trays through a poultry stunning process.

15. The method as recited in claim 14, further comprising the step of:
tilting each of the plurality of trays removing stunned poultry.

16. The method as recited in claim 14, where the stunning process comprises the steps of;
conveying the plurality of trays containing poultry through an induction phase chamber where the induction phase chamber comprises an atmosphere of increased volume CO₂ and increased volume O₂ with respect to ambient atmospheric conditions;
conveying the plurality of trays containing poultry through a stunning phase chamber where the stunning phase chamber comprises an atmosphere of increased volume CO₂ with respect to the atmosphere in the induction phase; and
conveying the plurality of trays containing poultry through a final-stunning phase chamber where the final stunning phase chamber comprises an atmosphere of increased volume CO₂ with respect to the stunning phase.

17. A method of preparing poultry for rendering comprising the steps of:
conveying a plurality of trays containing live poultry through an induction phase chamber where the induction phase chamber comprises an atmosphere of increased volume CO₂ and increase volume O₂ with respect to ambient atmospheric conditions;
conveying the plurality of trays containing poultry through a stunning phase chamber where the stunning phase chamber comprises an atmosphere of increased volume CO₂ with respect to the induction phase; and
conveying the plurality of trays containing poultry through a final stunning phase chamber where the final stunning phase chamber comprises an atmosphere of increased volume CO₂ with respect to the stunning phase.

18. The method as recited in claim 17, where the induction phase chamber comprises an atmosphere having a CO₂ content in the range of about 17% to about 37% by volume CO₂ and having an O₂ content in the range of about 15% to about 35% by volume O₂.

19. The method as recited in claim 18, where the stunning phase chamber increase volume of CO₂ is at least about 30% by volume CO₂.

20. The method as recited in claim 19, where the final stunning phase chamber increased volume of CO₂ is at least about 55% by volume CO₂.
